(19) United States
(12) Patent Application Publication
(10) Pub. No.: US 2014/0287639 A1
(43) Pub. Date: Sep. 25, 2014

(54) NANOWIRE COMPOSITE, COMPOSITE FILM, AND PREPARATION METHOD THEREOF

(71) Applicant: RESEARCH & BUSINESS FOUNDATION SUNGKYUNKWAN UNIVERSITY, Suwon-si (KR)

(72) Inventors: Hyoyoung LEE, Suwon-si (KR); Yang LI, Suwon-si (KR)

(73) Assignee: RESEARCH & BUSINESS FOUNDATION SUNGKYUNKWAN UNIVERSITY, Suwon-si (KR)

(21) Appl. No.: 14/291,622

(22) Filed: May 30, 2014

Related U.S. Application Data
(63) Continuation of application No. PCT/KR2013/002479, filed on Mar. 26, 2013.

(30) Foreign Application Priority Data
Nov. 29, 2012 (KR) 10-2012-0137279
Mar. 18, 2013 (KR) 10-2013-0028839

(51) Int. Cl. H01B 1/22; H01B 13/00

(52) U.S. Cl. CPC H01B 1/22; H01B 13/0036
USPC 442/64; 442/376; 442/172; 427/108; 427/110

(57) ABSTRACT

A nanowire composite, a nanowire composite film, a transparent electrode, a method of preparing a nanowire composite, and a method of preparing a nanowire composite film are provided. The nanowire composite includes metallic nanowires and an organic compound that connects the metallic nanowires to one another.

### CROSS-REFERENCE TO RELATED APPLICATIONS

This application is a continuation application of International Application No. PCT/KR2013/002479 filed Mar. 26, 2013, claiming priority based on Korean Patent Application No. 10-2012-0137279 filed Nov. 29, 2012, and No. 10-2013-0028839 filed on Mar. 18, 2013, in the Korean Intellectual Property Office, the entire disclosure of all of which are incorporated herein by reference for all purposes.

### BACKGROUND

1. Field

The following description relates to a nanowire composite, a film including a nanowire composite, a method of preparing a nanowire composite, a method of preparing a film including a nanowire composite, a UV curable hard coating film including a nanowire composite, a method of preparing a hard coating film, and a transparent electrode including a nanowire composite.

2. Description of Related Art

With the recent rapid development of portable display devices, a demand exists for transparent electrodes that are flexible and have sufficiently high transmittance to allow application in portable display devices. For transparent electrodes, indium tin oxides (ITO) have been often used. However, electrodes formed with ITOs are difficult to apply to flexible devices due to their high mechanical strength. In addition, the preparation of ITO electrodes requires a high temperature process.

In order to replace the ITO electrodes, various materials such as carbon nanotubes, graphene, and metallic nanowires have been studied. Metallic nanowires, such as silver nanowires (Ag NW), have superior electrical, thermal, optical properties, and are thus studied as materials for replacing the ITO electrodes (U.S. Patent Application No. 2009/0129004 A1, etc.). Since a discovery that a metallic nanowire film can be used as a transparent electrode in a solar cell, there have been continuous attempts to fabricate electrodes with metallic nanowires through various techniques, including transfer printing, spry coating, and bar coating. With these attempts, methods for preparing a metallic nanowire film, which is low cost and has superior transmittance and conductivity, are being continuously explored.

Without regards to the method for preparing a metallic nanowire film used, it is desirable to remove an insulating ligand, which is used for synthesis of metallic nanowires and solution dispersion, from the metallic nanowires. The insulating ligand results in mutual junction of the metallic nanowires, which causes reduction of conductivity. In order to remove the insulating ligand, heating, mechanical pressing, etching by acid, or others have been used. However, these methods may cause undesired damages to devices or require high-cost processes.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a nanowire composite includes metallic nanowires and an organic compound that connects the metallic nanowires to one another.

The metallic nanowires may include a metal selected from the group consisting of silver, gold, copper, platinum, iron, nickel, and a combination thereof.

The organic compound may include a compound selected from the group consisting of polydiallyldimethylammonium chloride (PDDA), polyacrylic acid (PAA), polyethylenimine, poly(methyl methacrylate), polyvinyl alcohol (PVA), 2,3-dimercapto-1-propanol, 1,8-octanedithiol, and a combination thereof.

The organic compound may be bound to surfaces of the metallic nanowires or junction parts of the metallic nanowires to connect the metallic nanowires to one another.

In another general aspect, a nanowire composite film includes a nanowire composite described above.

In another general aspect, a nanowire composite film includes a nanowire layer including a nanowire composite described above, and a coating layer including a graphene oxide, a reduced graphene oxide, or a mixture of a graphene oxide and a reduced graphene oxide disposed on the nanowire composite layer.

In another general aspect, a method of preparing a nanowire composite includes: applying a solution comprising an organic compound onto a substrate to form an organic compound-modified substrate, applying a solution comprising metallic nanowires onto the organic compound-modified substrate to form a nanowire layer, and immersing the nanowire layer in a solution comprising the organic compound to form a nanowire composite.

The metallic nanowires may include a metal selected from the group consisting of silver, gold, platinum, iron, nickel, and a combination thereof.

The applying of the solution comprising the metallic nanowires and the immersing of the nanowire layer may be performed more than once.

The general aspect of the method may further include: applying a solution comprising a graphene oxide, a reduced graphene oxide, or a mixture of a graphene oxide and a reduced graphene oxide on the nanowire composite to form a graphene oxide layer.

The applying of the solution comprising the metallic nanowires, the immersing of the nanowire layer, and the applying of the solution comprising a graphene oxide may be performed more than once.

The organic compound may include a compound selected from the group consisting of polydiallyldimethylammonium (PDDA) chloride, polyacrylic acid (PAA), polyethylenimine, poly(methyl methacrylate), polyvinyl alcohol (PVA), 2,3-dimercapto-1-propanol,1,8-octanedithiol, and a combination thereof.

In the immersing of the nanowire layer, the organic compound may be bound onto the nanowires such that the metallic nanowires are connected to one another by the organic compound.

The applying of the solution comprising the nanowires may involve applying a method selected from the group consisting of an immersing method, a spray coating method, a spin coating method, a bar coating method, a roll-to-roll method, and a combination thereof.

In another general aspect, a method of preparing a nanowire composite film involves: forming a graphene oxide layer on a nanowire composite layer comprising metallic nanowires and an organic compound; and coating a hard coating film on the graphene oxide layer.

The general aspect of the method may further involve reducing the graphene oxide layer to form a reduced graphene oxide layer on the nanowire composite layer, after the formation of the graphene oxide layer on the nanowire composite layer.

The nanowire composite film may include a compound selected from the group consisting of acryl lysine; polyvinyalcohol (PVA), poly(ethylene glycol)diacrylate (PEGDA); poly(3,4-ethylenedioxythiophene):poly(styrene sulfonate) (PEDOT:PSS); TiO₂/PEDOT; PSS; teflon; a silver nanowire/polymer composite; a silane coupling agent selected from the group consisting of methacryloxypropyl trimethoxysilane (MPTMS), glycidoxypropyl trimethoxysilane (GPTMS), vinyltriethoxysilane (VIES), methyltriethoxysilane (MTES), tetraethylorthosilicate (TEOS), methacryloxy propyltrimethoxysilane (MPTMS), and mixtures thereof; a high refractive material selected from the group consisting of titanium isopropoxide (TTIP), (3-glycidoxypropyl)trimethoxysilane (GPTMS) and mixtures thereof; and a combination thereof.

The coating of the hard coating film may involve adding a photoinitiator.

In another general aspect, a nanowire composite film is prepared according to the method described above, and the film includes a nanowire composite layer comprising metallic nanowires and an organic compound, a graphene oxide or reduced graphene oxide layer, and a hard coating layer.

In another general aspect, a transparent electrode includes the nanowire composite film described above, and the nanowire composite film is a UV curable coating film.

In another general aspect, a nanowire composite film includes a nanowire composite layer comprising a nanowire composite described above, and a hard coating layer disposed on the nanowire composite layer.

Other features and aspects will be apparent from the following detailed description, the drawings, and the claims.

### BRIEF DESCRIPTION OF THE DRAWINGS

FIG. 1 is a schematic view of an example of a nanowire composite in accordance with the present disclosure.

FIG. 2 is a schematic view of an example of a nanowire composite film in accordance with the present disclosure.

FIG. 3 is a flow chart of an example of a method of preparing a nanowire composite in accordance with the present disclosure.

FIG. 4 is a schematic view of an example of a method for preparing a nanowire composite in accordance with the present disclosure.

FIG. 5 is a flow chart of an example of a method of preparing a UV curable hard coating film including a nanowire composite in accordance with the present disclosure.

FIG. 6A is a schematic view of an example of a hard coating film including a nanowire composite in accordance with the present disclosure.

FIG. 6B is a schematic view of another example of a hard coating film including a nanowire composite in accordance with the present disclosure.

FIG. 6C is a schematic view of an example of a transparent electrode including a hard coating film in accordance with the present disclosure.

FIG. 7 is a graph obtained from measuring transmittance and sheet resistance of an example of a nanowire composite film in accordance with the present disclosure.

FIG. 8 is a graph for transmittance of a nanowire composite film by wavelengths in accordance with the present disclosure.

FIG. 9 is a graph showing a sheet resistance value of a nanowire composite film in accordance with the present disclosure.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Described herein is an example of a nanowire composite or a metallic nanowire-organic compound composite, in which metallic nanowires are connected to one another by an organic compound serving as a glue so that the junction conductivity of the metallic nanowires is improved. Further described is an example of a film including the nanowire composite.

Further described herein is an example of a method of improving the contacts of the metallic nanowires through a graphene oxide and/or reduced graphene oxide coating film formed on the nanowire composite so as to further improve the conductivity property, and simultaneously, to express a hydrophilic or hydrophobic film property.

Described herein is an example of a method of preparing a nanowire composite through a simple method, which does not involve performing a high-cost heat treatment process.

An example of a method of preparing a nanowire composite described herein does not involve the use of insulating ligands, which cause a reduction of conductivity. An example of a nanowire composite described herein does not include an insulating ligand. Thus, the methods of removing the insulating ligand, including heating, mechanical pressing, etching by acid, that may cause undesired damages to devices with a transparent electrode formed therewith may be avoided. Accordingly, the example may result in improving the junction conductivity of the metallic nanowires.

However, the present disclosure is not limited to those described above.

According to an example provided herein, a nanowire composite includes metallic nanowires and an organic compound glue for connecting the metallic nanowires to one another.

The metallic nanowires may include a metal selected from the group consisting of silver, gold, copper, platinum, iron, nickel, and combinations thereof.

A coating film containing a graphene oxide, a reduced graphene oxide, or a mixture of a graphene oxide and a reduced graphene oxide may be additionally stacked on a layer of the nanowire composite.

The organic compound glue may include a member selected from the group consisting of polydiallyldimethylammonium chloride (PDDA), polyacrylic acid (PAA), polyethylenimine, poly(methyl methacrylate), polyvinyl alcohol (PVA), 2,3-dimercapto-1-propanol, 1,8-octanedithiol, and combinations thereof.

The organic compound glue may be bound to surfaces of the metallic nanowires or junction parts of the metallic nanowires to connect the metallic nanowires to one another.

In another example, a film comprises the nanowire composite.

In another example, a method for preparing a nanowire composite includes a first step of applying a solution containing an organic compound onto a substrate to form an organic compound-modified substrate; a second step of applying a solution containing metallic nanowires onto the organic compound-modified substrate to prepare a metallic nanowire film; and a third step of immersing the metallic nanowire film in a solution containing an organic compound to form a nanowire composite.

The metallic nanowires may include a member selected from the group consisting of silver, gold, platinum, iron, nickel, and combinations thereof.

The method may include repeatedly conducting the second and third steps.

The method may further include a fourth step of applying a solution containing a graphene oxide, a reduced graphene oxide, or a mixture of a graphene oxide and a reduced graphene oxide onto the nanowire composite to form a graphene oxide layer.

The method may include repeatedly conducting the second to fourth steps.

The organic compound may include a member selected from the group consisting of polydiallyldimethylammonium (PDDA) chloride, polyacrylic acid (PAA), polyethylenimine, poly(methyl methacrylate), polyvinyl alcohol (PVA), 2,3-dimercapto-1-propanol,1,8-octanedithiol, and combinations thereof.

In the third step, the organic compound may be bound onto the metallic nanowires, and thus, the metallic nanowires may be connected to one another by the organic compound.

The application may be conducted by a method selected from the group consisting of an immersing method, spray coating, spin coating, bar coating, a roll-to-roll method, and combinations thereof.

In another example, a method for preparing a UV curable hard coating film include forming a graphene oxide layer on a nanowire composite; and coating a hard coating film on the graphene oxide layer or a nanowire composite layer.

The method may further include reducing the graphene oxide layer to form a reduced graphene oxide layer on the nanowire composite layer, after the formation of the graphene oxide layer on the nanowire composite layer.

The hard coating film may include a member selected from the group consisting of acryl lysine; polyvinyalcohol (PVA), poly(ethylene glycol)diacrylate (PEGDA); poly(3,4-ethylenedioxythiophene):poly(styrene sulfonate) (PEDOT:PSS); TiO₂/PEDOT; PSS; teflon; a silver nanowire/polymer composite; a silane coupling agent selected from the group consisting of methacryloxypropyl trimethoxysilane (MPTMS), glycidoxypropyl trimethoxysilane (GPTMS), vinyltriethoxysilane (VTES), methyltriethoxysilane (MTES), tetraethylorthosilicate (TEOS), methacryloxy propyltrimethoxysilane (MPTMS), and mixtures thereof; a high refractive material selected from the group consisting of titanium isopropoxide (TTIP), (3-glycidoxypropyl)trimethoxysilane (GPTMS) and mixtures thereof; and combinations thereof.

The step of coating the hard coating film may include adding a photoinitiator.

In another example, a UV curable hard coating film, which is prepared according to the aspect of the present disclosure includes a nanowire composite layer including metallic nanowires and an organic compound glue; a graphene oxide or reduced graphene oxide layer; and a hard coating film.

In another example, a transparent electrode includes the UV curable hard coating film of the aspect of the present disclosure.

Hereinafter, an example of the present disclosure will be described in detail with reference to the accompanying drawings so that inventive concept may be readily implemented by those skilled in the art. However, it is to be noted that the present disclosure is not limited to the illustrative examples but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element.

Through the whole document, the term “on” that is used to designate a position of one element with respect to another element includes both a case that the one element is adjacent to the another element and a case that any other element exists between these two elements.

Throughout the whole document, the term “comprises or includes” and/or “comprising or including” means that one or more other components, steps, operations, and/or the existence or addition of elements are not excluded in addition to the described components, steps, operations and/or elements. The terms “about or approximately” or “substantially” used throughout the whole document are intended to have meanings close to numerical values or ranges specified with an allowable error and intended to prevent accurate or absolute numerical values disclosed for understanding of the present invention from being illegally or unfairly used by any unconscionable third party. The term “step of” used throughout the whole document does not mean “step for”.

Through the whole document, the term “combinations of” included in Markush type description means mixture or combinations of one or more components, steps, operations and/or elements selected from a group consisting of components, steps, operation and/or elements described in Markush type and thereby means that the disclosure includes one or more components, steps, operations and/or elements selected from the Markush group.

Throughout the whole document, the description “A and/or B” means “A or B, or A and B.”

A first aspect of the present disclosure relates to a nanowire composite, including metallic nanowires and an organic compound glue for connecting the metallic nanowires to one another.

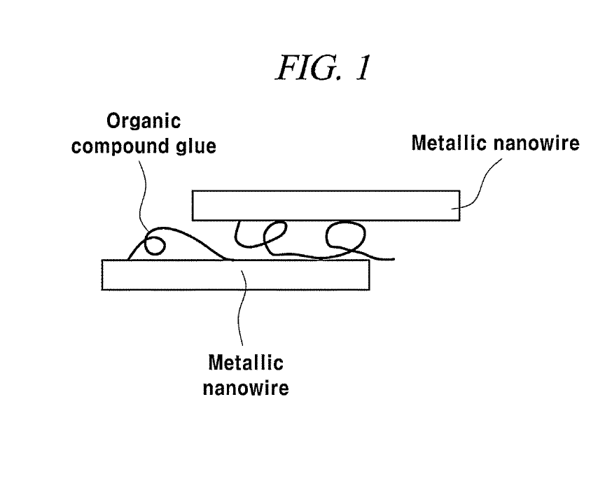

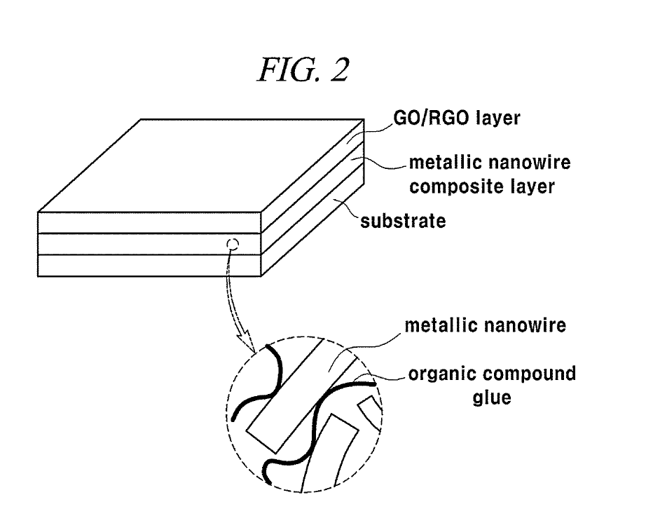

FIGS. 1 and 2 are schematic views illustrating an example of a nanowire composite in accordance with the present disclosure.

Referring to FIG. 1, the metallic nanowires of the nanowire composite are connected to one another by an organic compound glue. The organic compound glue increases the junction force of the metallic nanowires and acts as a solid electrolyte. Accordingly, the junction conductivity of the metallic nanowires is increased by the organic compound glue. Further, the hydrophilicity of the nanowire composite can be increased by the organic compound glue. As a result, the nanowire composite can be transferred onto various substrates by using a solution method.

The metallic nanowires may include a metal selected from the group consisting of, for example, silver, gold, copper, platinum, iron, nickel, and combinations thereof, but may not be limited thereto. The metal may include, for example, silver, gold, copper, platinum, iron, nickel, or different types of composite metals such as copper-nickel, copper-silver, copper-gold, and copper-platinum, but may not be limited thereto.

For the organic compound glue, any one that can increase the junction force of the metals and is known in the art of the present disclosure can be used. For example, a member selected from the group consisting of polydiallyldimethylammonium chloride (PDDA), polyacrylic acid (PAA), polyethylenimine, poly(methyl methacrylate), polyvinyl alcohol (PVA), 2,3-dimercapto-1-propanol, 1,8-octanedithiol, and combinations thereof can be used. However, the present disclosure may not be limited thereto.

The organic compound glue may be bound to, for example, surfaces of the metallic nanowires or junction parts of the metallic nanowires so as to connect the metallic nanowires to one another, but may not be limited thereto.

In an example illustrated in FIG. 2 of the present disclosure, a graphene oxide (GO) and/or a reduced graphene oxide (RGO) layer may be further stacked on a nanowire composite layer including metallic nanowires and an organic compound that serves as a glue. However, the present disclosure may not be limited thereto. If the graphene oxide layer is stacked thereon, the hydrophilicity of the nanowire composite can be increased. Further, the haze problem occurring in the conventional metallic nanowires is resolved so that an adhesion of the nanowire composite can be increased. Since the organic compound includes positive charge functional groups, and the graphene oxide includes negative charge functional groups, the organic compound and the graphene oxide can be bound to each other by strong ionic bond. The graphene oxide can be reduced to a reduced graphene oxide through various methods, such as thermal reduction, various chemical methods, and so on. The reduced graphene oxide has hydrophobicity. Accordingly, it is possible to easily modify the surface of the nanowire composite to be hydrophilic or hydrophobic.

A second aspect of the present disclosure can provide a film including the nanowire composite. The film may be transparent, and accordingly, can be applied to various types of transparent electrodes. Since the film may have hydrophilicity or hydrophobicity depending on whether or not it further includes a graphene oxide and/or a reduced graphene oxide, it can be easily stacked on various substrates.

A third aspect of the present disclosure can provide a method for preparing a nanowire composite, including: a first step of applying a solution containing an organic compound onto a substrate to form an organic compound-modified substrate; a second step of applying a solution containing metallic nanowires onto the organic compound-modified substrate to prepare a metallic nanowire film; and a third step of immersing the metallic nanowire film in a solution containing an organic compound to form a nanowire composite. The organic compound may be a polymer.

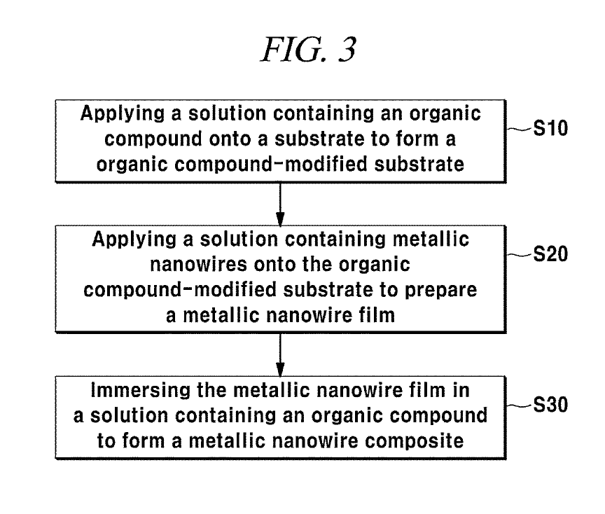

FIG. 3 is a flow chart of the method for preparing the nanowire composite in accordance with an example embodiment of the present disclosure.

Referring to FIG. 3, first, a solution containing an organic compound glue is applied onto a substrate to form an organic compound-modified substrate, in S10. In order to improve a bonding force between the substrate and the organic compound glue, a preconditioning process that increases hydrophilicity of the substrate may be performed. For the substrate, a substrate known in the art of the present disclosure can be used. The substrate may be a hard substrate, such as a glass substrate, or a flexible substrate, such as polyethyleneterephthalate, (PET), polyethylene naphthalate (PEN), or polyimide (PI), but may not be limited thereto. By modifying the substrate with the organic compound, and thereby, increasing the junction force between the metallic nanowires and the substrate, a metallic nanowire film can be easily prepared later.

The above-described application can be performed by any method known in the art of the present disclosure. For example, the application may be conducted by a method selected from the group consisting of an immersing method, spray coating, spin coating, bar coating, a roll-to-roll method and combinations thereof, but may not be limited thereto.

Subsequently, a solution containing metallic nanowires is applied onto the organic compound-modified substrate to prepare a metallic nanowire film, in S20.

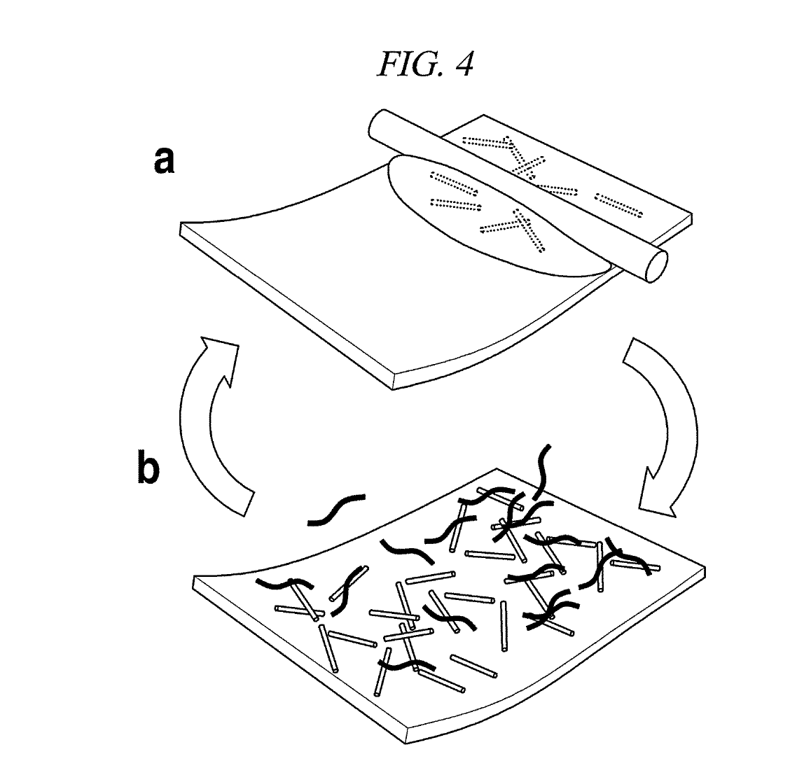

For the method of applying the solution containing the metallic nanowires onto the organic compound-modified substrate, a method known in the art of the present disclosure can be used. For example, as shown in FIG. 4 a, the metallic nanowires can be applied onto the organic compound-modified substrate by applying the metallic nanowire solution onto a wire-shaped rod and rolling the rod on the organic compound-modified substrate. The solution may be a homogenous mixture of the metallic nanowire in a non-reactive liquid solvent, for example. The metal of the metallic nanowires may include a member selected from the group consisting of, for example, silver, gold, copper, platinum, iron, nickel, and combinations thereof, but may not be limited thereto. The metal may include, for example, silver, gold, copper, platinum, iron, nickel, or, different types of composite metals such as copper-nickel, copper-silver, copper-gold, and copper-platinum, but may not be limited thereto.

Subsequently, the metallic nanowire film is immersed in a solution containing an organic compound to form a nanowire composite, in S30.

The organic compound may include, for example, one selected from the group consisting of polydiallyldimethylammonium (PDDA) chloride, polyacrylic acid (PAA), polyethylenimine, poly(methyl methacrylate), polyvinyl alcohol (PVA), 2,3-dimercapto-1-propanol,1,8-octanedithiol, and combinations thereof, but may not be limited thereto. While the metallic nanowire film is immersed in the solution containing the organic compound, the organic compound is bound onto the metallic nanowires to connect the metallic nanowires to one another, as shown in diagram b of FIG. 4.

In an example according to the present disclosure, the nanowire composite, which has an improved bonding force between the metallic nanowires and the organic compound, can be prepared by repeatedly conducting the second step (S20) and the third step (S30).

In order to improve the stability of the nanowire composite, a graphene oxide layer and/or a reduced graphene oxide layer may be further formed on the nanowire composite by applying a graphene oxide, a reduced graphene oxide, or a solution containing a mixture of a graphene oxide and a reduced graphene oxide onto the composite. The formed graphene oxide layer can increase the hydrophilicity of the nanowire composite and can prevent the nanowire composite from being separated from the substrate as time lapses. The formed reduced graphene oxide layer can increase the hydrophobicity of the nanowire composite. The reduced graphene oxide layer can be formed by reducing an already formed graphene oxide layer through various methods, for example, thermal reduction, and so on, as well as applying a solution containing a reduced graphene oxide, but may not be limited thereto. The solution can be applied by various methods, e.g., spray coating, spin coating, and/or immersion coating, but may not be limited thereto.

A fourth aspect of the present disclosure relates to a method for preparing a UV curable hard coating film, including forming a graphene oxide layer on a nanowire composite; and coating a hard coating film on the graphene oxide/nanowire composite layer.

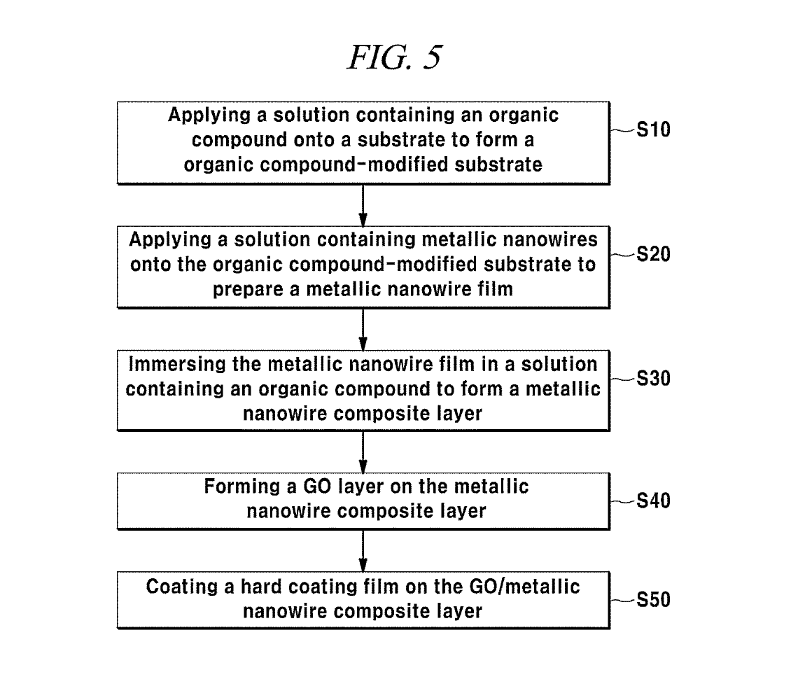

FIG. 5 is a flow chart illustrating an example of a method for preparing the UV curable hard coating film including the nanowire composite in accordance with one example of the present disclosure.

First, after a nanowire composite is formed according to the third aspect of the present disclosure as described in FIG. 3, a graphene oxide layer is formed on the nanowire composite, in S40. The method of forming the graphene oxide layer may include application by various methods, for example, spray coating, spin coating, and/or immersion coating, but may not be limited thereto. Once the graphene oxide layer is formed on the nanowire composite prior to coating of a hard coating film, the graphene oxide layer protects the metallic nanowires, and thereby, preventing a hard coating material to be additionally stacked from entering into junctions of the nanowires. Further, it is possible to form a chemically and physically stable hard coating film for transparent plastic surface modification, while maintaining conventional low resistance.

In accordance with an illustrative embodiment of the present disclosure, it is possible to further include reducing the graphene oxide layer to form a reduced graphene oxide layer on the nanowire composite, after the formation of the graphene oxide layer on the nanowire composite, in S40. However, the present disclosure may not be limited thereto. The reduced graphene oxide layer can be formed on the nanowire composite by reducing the graphene oxide layer formed in S40 through various methods, for example, thermal reduction, but may not be limited thereto. The formed graphene oxide layer can increase the hydrophilicity of the nanowire composite. The formed reduced graphene oxide layer can increase the hydrophobicity of the nanowire composite. The formation of the graphene oxide layer and/or the reduced graphene oxide layer can improve the stability of the nanowire composite and prevent the nanowire composite from being separated from the substrate as time lapses.

Subsequently, a hard coating film is coated on the graphene oxide/nanowire composite, in S50. The method of coating with the hard coating film may include, for example, spray coating, spin coating, and/or immersion coating, but may not be limited thereto. By further coating with the hard coating film, the stability of the graphene oxide/nanowire composite in accordance with the present disclosure can be increased.

In accordance with an example of the present disclosure, the hard coating film may include a member selected from the group consisting of acryl lysine, polyvinyalcohol (PVA), poly(ethylene glycol)diacrylate (PEGDA), poly(3,4-ethylenedioxythiophene):poly(styrene sulfonate) (PEDOT:PSS), TiO₂/PEDOT, PSS, teflon, a silver nanowire/polymer composite, a silane coupling agent, a high refractive substance, and combinations thereof, but may not be limited thereto. The silane coupling agent may include a member selected from the group consisting of, for example, methacryloxypropyl trimethoxysilane (MPTMS), glycidoxypropyl trimethoxysilane (GPTMS), vinyltriethoxysilane (VTES), methyltriethoxysilane (MTES), tetraethylorthosilicate (TEOS), methacryloxy propyltrimethoxysilane (MPTMS), and mixtures thereof. The high refractive substance may include a member selected from the group consisting of titanium isopropoxide (TTIP), 3-glycidoxypropyl)trimethoxysilane (GPTMS), and mixtures thereof. However, the present disclosure may not be limited thereto.

In accordance with an example of the present disclosure, the step of coating with the hard coating film (S50) may include adding a photoinitiator, but may not be limited thereto. For example, the photoinitiator may be 1-hydroxy-cyclohexyl-phenyl ketone, but may not be limited thereto.

A fifth aspect of the present disclosure can provide a UV curable hard coating film, which is prepared according to the fourth aspect of the present disclosure and includes a nanowire composite layer; a graphene oxide layer or a reduced graphene oxide layer; and a hard coating film.

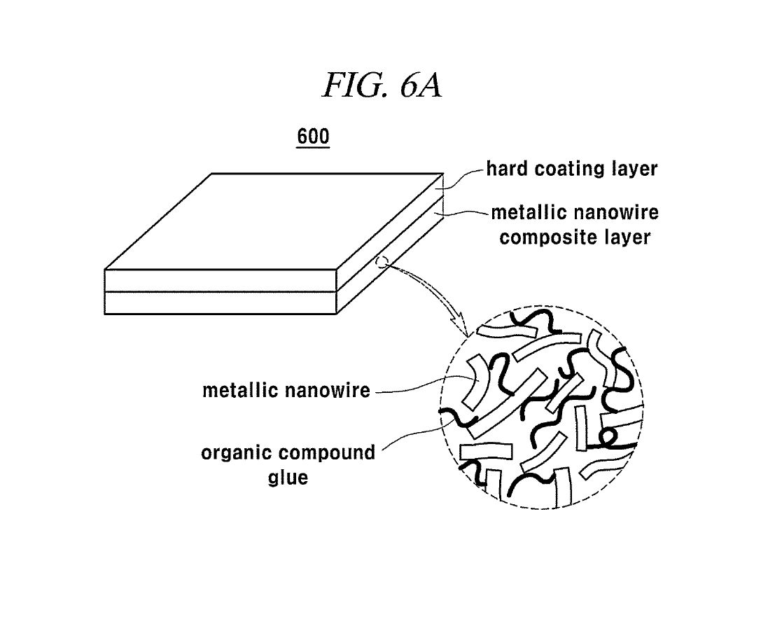

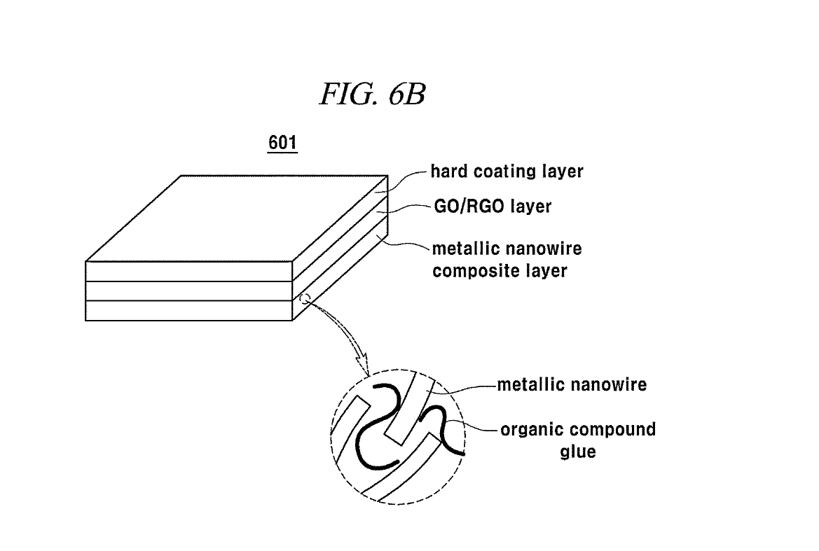

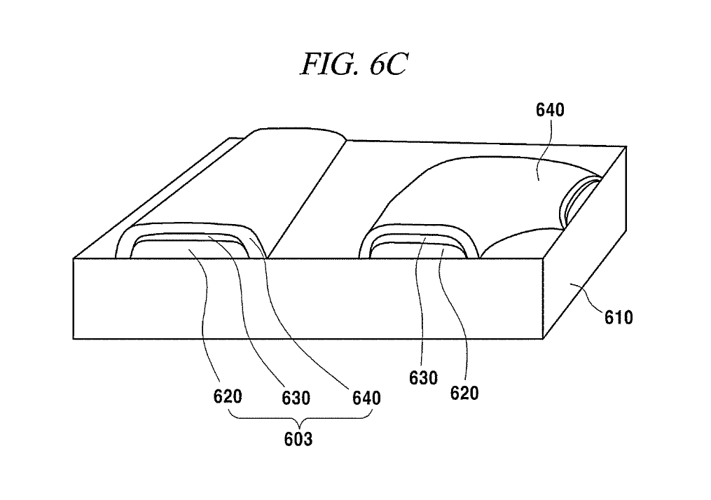

FIGS. 6A and 6B each include a schematic view of an example of a UV curable hard coating film including a nanowire composite layer in accordance with the present disclosure.

Referring to FIG. 6A, a UV curable hard coating film 600 includes a nanowire composite layer, on which a hard coating film is staked. Referring to FIG. 6B, a UV curable hard coating film 601 includes a nanowire composite layer on which a graphene oxide or reduced graphene oxide layer is stacked. A UV curable hard coating film 601 further includes a UV curable coating layer stacked on the graphene oxide or reduced graphene oxide layer, but the structure of the hard coating film is not limited thereto.

In this case, the film that includes the nanowire composite may have the structure illustrated in FIG. 6A or 6B, depending on a position on which the hard coating film is coated. In the example illustrated in FIG. 6B, the hard coating film is coated to be bound onto the graphene oxide and/or reduced graphene oxide layer. In the example illustrated in FIG. 6A, the hard coating film is coated to be bound to the nanowire composite layer. However, the present disclosure may not be limited thereto. Further, while the nanowire composite layer and the graphene oxide/reduced graphene oxide layer are illustrated as two separate layers in 6B, in other examples, the graphene oxide or reduced graphene oxide may be included in the nanowire composite layer, or the two layers may be fused as to form an integrated layer. Further, a plurality of graphene oxide/reduced graphene oxide layers and a plurality of nanowire composite layers may be formed alternatively in a multilayer structure. The iteration of each types of layers may range from 2 to 7, for example.

According to the present disclosure, it is possible to obtain a UV curable hard coating film, which has improved stability, by further coating the hard coating film on the nanowire composite layer or a multi-layer structure including the nanowire composite layer and further including the graphene oxide and/or reduced graphene oxide layer. The UV curable hard coating film can be applied as a hard coating film for transparent plastic surface modification, which is more chemically and physically stable while maintaining conventional low resistance.

A sixth aspect of the present disclosure can provide a transparent electrode including the UV curable hard coating film according to the fifth aspect of the present disclosure. The location of the nanowire composite layer on a substrate may be, for example, patterned using a mask, forming a transparent electrode on a suitable substrate. In another example, the nanowire composite layer may be patterned on a first substrate, and transferred to a second substrate.

FIG. 6C includes a schematic view of a substrate 610 on which a metallic nanowire composite layer 620 is patterned to from a transparent electrode 603. In this example, the nanowire composite layer 620 is coated with a graphene oxide and/or reduced graphene oxide layer 630, and a hard coating layer 640. In this example, the hard coating layer 640 is formed with a surface area that is greater than the patterned nanowire composite layer 620. However, in another example, the surface area of the graphene oxide and/or reduced graphene oxide layer 630 and the hard coating layer 640 may be vary, or even cover the gap between electrodes 603 over the entire substrate 603. The substrate 610 may be a flexible substrate or an inflexible, hard substrate. For example, the substrate 610 may be a PET substrate, a glass substrate, or a flexible synthetic polymer substrate.

According to the present disclosure, the nanowire composite, the nanowire composite further including the graphene oxide and/or reduced graphene oxide layer, and the film including the nanowire composite can be applied as transparent electrodes for various devices.

Hereinafter, an example according to the present disclosure will be described in detail with reference to examples; however, the present disclosure is not limited thereto.

### EXAMPLES

### Example 1

### Graphene Oxide/Nanowire-Organic Compound Composite Film

1) In order to improve hydrophilicity of a substrate, a PET substrate was subjected to an O₂ plasma treatment for 3 minutes. Subsequently, the PET substrate was immersed in a PDDA solution (1 mg/mL) for 20 minutes such that the PDDA was absorbed onto the PET substrate.

2) Subsequently, silver nanowires were applied onto the PET substrate, on which the PDDA was absorbed, by using a wire-shaped rod coated with a silver nanowire IPA (isopropylalcohol) solution (0.5 mg/mL).

3) Subsequently, the PET substrate, to which the silver nanowires were applied, was immersed in a PDDA solution (1 mg/mL) for 5 minutes such that the silver nanowires and the PDDA were connected to each other.

The processes 2) and 3) were conducted once to 7 times to prepare 7 types of silver nanowire-organic compound composites.

Gold nanowire-organic compound composites and other metal (for example, copper, platinum, iron or nickel) nanowire-organic compound composites were prepared in the same manner as described above.

Subsequently, for formation of a graphene oxide coating film on the prepared metal (for example, silver, gold, copper, platinum, iron, or nickel) nanowire-organic compound composite, an aqueous solution, in which graphene oxide is dispersed, was applied onto the nanowire composite through spray coating, spin coating, and immersion coating so as to form a graphene oxide film thereon.

The formed graphene oxide coating film was changed into a reduced graphene oxide (RGO) by using various reduction methods. With respect to the various reduction methods, the reduction was conducted by increasing a temperature or using reducing agents (HI, hydrazine NH₂NH₂. NaBH₄, etc.). When the graphene oxide is reduced to the reduced graphene oxide by increasing a temperature, the reduction was conducted at less than approximately 150° C., which may vary depending on the type of the substrate. When the reduction is conducted by using a solid reducing agent such as NaBH₄, the graphene oxide film could be reduced to the reduced graphene oxide film by dissolving a solid reducing agent in water or an organic solvent, and subsequently, immersing a graphene oxide/nanowire-organic compound composite therein. In addition, when the reduction is conducted by using a steam type of a reducing agent such as HI or NH₂NH₂, the reduction was conducted by holding a graphene oxide/nanowire-organic compound composite film in the air. In case of using a reducing agent, the reducing agent was selected depending on the metal nanowires used. For example, since gold nanowires are stable to both a temperature and a reducing agent, it was possible to use both the method of increasing a temperature and the method of using a reducing agent. However, since silver nanowires and copper nanowires are reactive to the reducing agent, the method of increasing a temperature was mostly used. However, if the graphene oxide coating film is thick even in case of the silver nanowires and the copper nanowires, using a steam type of a reducing agent such as HI or NH₂NH₂ was possible.

### Example 2

### UV Curable Hard Coating Film

A mixture solution was prepared by mixing 2 wt % poly(ethylene glycol)diacrylate (PEGDA), which is a type of acryl lysine, and 1-hydroxy-cyclohexyl-phenyl ketone, which is a radical photoinitiator, at a weight ratio of 50:1. The mixture solution was subject to 500 rpm spin coating to be stacked on the film prepared in Example 1, and then, dried by light in a nitrogen environment for about 1 minute. As a result, a hard coating film was obtained.

### Experimental Example

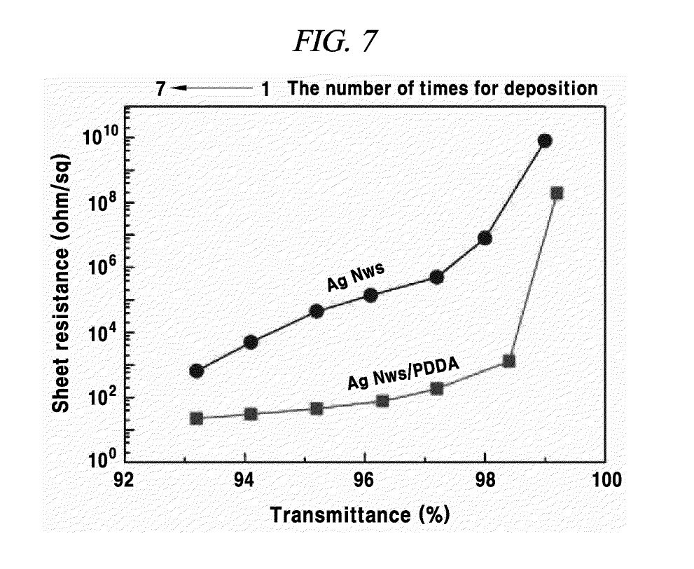

Sheet resistance and transmittance of each of the 7 silver nanowire-organic compound composites and a pure silver nanowire film was measured. FIG. 7 provides the measurement results. As shown in FIG. 7, it was observed that the sheet resistance and the transmittance of the silver nanowire-organic compound composites according to the examples of the present disclosure are similar or superior to those of the pure silver nanowire depending on the number of times for deposition. The gold nanowire-organic compound composites and the copper nanowire-organic compound composites exhibited almost similar results. The present document provides the properties of the representative silver nanowires, which are mostly used at the present time.

According to one example, the light transmittance of a nanowire composite film may range from approximately 93 to 100%, 94 to 100%, or 95 to 99%. The sheet resistance of the nanowire composite film may range from approximately 1×10¹ to 1×10⁸ ohm/sq, or 1×10¹ to 1×10⁴ ohm/sq, 1×10¹ to 1×10³ ohm/sq, 10 to 100 ohm/sq, or 15 to 50 ohm/sq, with a stable sheet resistance in that range for a 25-day period or longer.

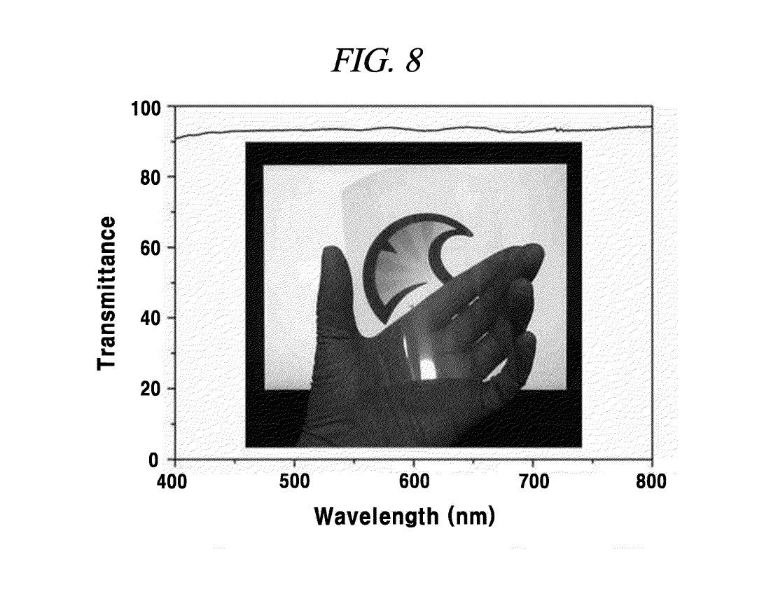

In addition, referring to FIG. 8, it was observed that regular and superior transmittance was exhibited over entire wavelength areas.

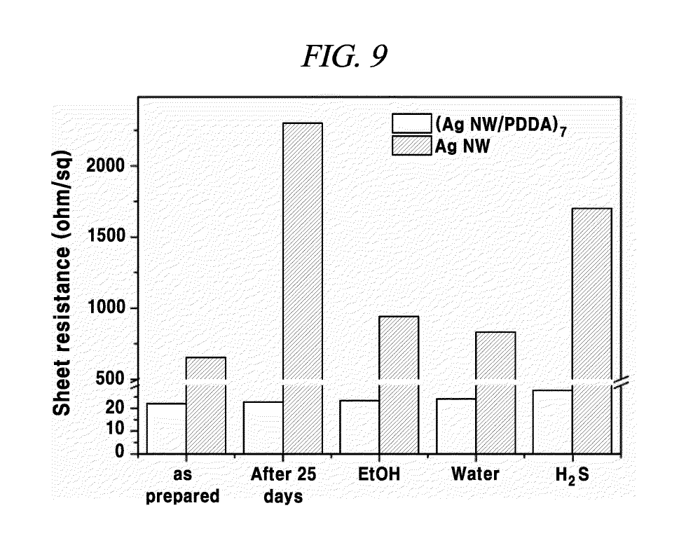

FIG. 9 provides data for comparison of sheet resistance of the pure silver nanowire and the silver nanowire-PDDA (Ag NW-PDDA) composite film. When a PDDA organic compound is added, the sheet resistance almost did not change in spite of the lapse of time over a 25-day period. Further, the change of the sheet resistance was not significant in spite of exposure to air, water, an ethanol solvent, or hydrogen sulfide, confirming that the silver nanowire-PDDA composite film is highly stable.

An example of a nanowire composite according to the present disclosure can increase a junction force of the metallic nanowires since the metallic nanowires are directly connected to one another by an organic compound glue, and can improve the junction conductivity of the metallic nanowires since the organic compound glue acts as a solid electrolyte.

Because an example of a nanowire composite according to the present disclosure can be prepared by a simple method that does not involve a high temperature heat treatment, production costs can be reduced. Because an example of a nanowire composite according to the present disclosure is prepared by a solution method, it can be applied to any substrate. Further, an example of a nanowire composite according to the present disclosure can be prepared by an environmentally friendly method at low costs.

In one example in which a graphene oxide is stacked on the nanowire composite, the graphene oxide is highly strongly bound to the nanowire composite. For example, strong ionic bond occurs between the organic compound having positive charge function groups and the graphene oxide having negative charge functional groups. The graphene oxide has a hydrophilic surface and can be reduced to a reduced graphene oxide, which has a hydrophobic property, through various methods such as a thermal reduction method, a chemical method, and the like.

A finally produced nanowire composite, a nanowire composite further including a graphene oxide and/or reduced graphene oxide layer, and a film including the nanowire composite can be applied as transparent electrodes for various devices as well as UV curable hard coating films.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A nanowire composite, comprising metallic nanowires and an organic compound that connects the metallic nanowires to one another.

2. The nanowire composite of claim 1,
wherein the metallic nanowires comprises a metal selected from the group consisting of silver, gold, copper, platinum, iron, nickel, and a combination thereof.

3. The nanowire composite of claim 1,
wherein the organic compound comprises a compound selected from the group consisting of polydiallyldimethylammonium chloride (PDDA), polyacrylic acid (PAA), polyethylenimine, poly(methyl methacrylate), polyvinyl alcohol (PVA), 2,3-dimercapto-1-propanol, 1,8-octanedithiol, and a combination thereof.

4. The nanowire composite of claim 1,
wherein the organic compound is bound to surfaces of the metallic nanowires or junction parts of the metallic nanowires to connect the metallic nanowires to one another.

5. A nanowire composite film, comprising the nanowire composite according to claim 1.

6. A nanowire composite film, comprising:
a nanowire layer comprising the nanowire composite according to claim 1; and
a coating layer comprising a graphene oxide, a reduced graphene oxide, or a mixture of a graphene oxide and a reduced graphene oxide disposed on the nanowire composite layer.

7. A method of preparing a nanowire composite, the method comprising:
applying a solution comprising an organic compound onto a substrate to form an organic compound-modified substrate;
applying a solution comprising metallic nanowires onto the organic compound-modified substrate to form a nanowire layer; and
immersing the nanowire layer in a solution comprising the organic compound to form a nanowire composite.

8. The method of claim 7,
wherein the metallic nanowires comprises a metal selected from the group consisting of silver, gold, platinum, iron, nickel, and a combination thereof.

9. The method of claim 7, wherein the applying of the solution comprising the metallic nanowires and the immersing of the nanowire layer are performed more than once.

10. The method of claim 7, further comprising:
applying a solution comprising a graphene oxide, a reduced graphene oxide, or a mixture of a graphene oxide and a reduced graphene oxide on the nanowire composite to form a graphene oxide layer.

11. The method of claim 10, wherein the applying of the solution comprising the metallic nanowires, the immersing of the nanowire layer, and the applying of the solution comprising a graphene oxide are performed more than once.

12. The method of claim 7,
wherein the organic compound comprises a compound selected from the group consisting of polydiallyldimethylammonium (PDDA) chloride, polyacrylic acid (PAA), polyethylenimine, poly(methyl methacrylate), polyvinyl alcohol (PVA), 2,3-dimercapto-1-propanol,1,8-octanedithiol, and a combination thereof.

13. The method of claim 7,
wherein, in the immersing of the nanowire layer, the organic compound is bound onto the nanowires such that the metallic nanowires are connected to one another by the organic compound.

14. The method of claim 7,
wherein the applying of the solution comprising the nanowires comprises applying a method selected from the group consisting of an immersing method, a spray coating method, a spin coating method, a bar coating method, a roll-to-roll method, and a combination thereof.

15. A method of preparing a nanowire composite film, comprising:
forming a graphene oxide layer on a nanowire composite layer comprising metallic nanowires and an organic compound; and
coating a hard coating film on the graphene oxide layer.

16. The method of claim 15, further comprising reducing the graphene oxide layer to form a reduced graphene oxide layer on the nanowire composite layer, after the formation of the graphene oxide layer on the nanowire composite layer.

17. The method of claim 15,
wherein the nanowire composite film comprises a compound selected from the group consisting of acryl lysine; polyvinyalcohol (PVA), poly(ethylene glycol)diacrylate (PEGDA); poly(3,4-ethylenedioxythiophene):poly(styrene sulfonate) (PEDOT:PSS); TiO₂/PEDOT; PSS; teflon; a silver nanowire/polymer composite; a silane coupling agent selected from the group consisting of methacryloxypropyl trimethoxysilane (MPTMS), glycidoxypropyl trimethoxysilane (GPTMS), vinyltriethoxysilane (VIES), methyltriethoxysilane (MTES), tetraethylorthosilicate (TEOS), methacryloxy propyltrimethoxysilane (MPTMS), and mixtures thereof; a high refractive material selected from the group consisting of titanium isopropoxide (TTIP), (3-glycidoxypropyl)trimethoxysilane (GPTMS) and mixtures thereof; and a combination thereof.

18. The method of claim 15,
wherein the coating of the hard coating film comprises adding a photoinitiator.

19. A nanowire composite film, the film prepared according to claim 15, and the film comprising:
a nanowire composite layer comprising metallic nanowires and an organic compound;
a graphene oxide or reduced graphene oxide layer; and
a hard coating layer.

20. A transparent electrode comprising the nanowire composite film of claim 19, wherein the nanowire composite film is a UV curable coating film.

21. A nanowire composite film, comprising a nanowire composite layer comprising the nanowire composite of claim 1, and a hard coating layer disposed on the nanowire composite layer.
